(19) United States
(12) Patent Application Publication
(10) Pub. No.: US 2021/0319226 A1
(43) Pub. Date: Oct. 14, 2021

(54) FACE CLUSTERING IN VIDEO STREAMS

(71) Applicant: NEC Laboratories America, Inc., Princeton, NJ (US)

(72) Inventors: Biplob Debnath, Princeton, NJ (US); Srimat Chakradhar, Manalapan, NJ (US); Giuseppe Coviello, Princeton, NJ (US); Murugan Sankaradas, Dayton, NJ (US)

(21) Appl. No.: 17/194,911

(22) Filed: Mar. 8, 2021

Related U.S. Application Data
(60) Provisional application No. 63/035,292, filed on Jun. 5, 2020.
(60) Provisional application No. 63/009,701, filed on Apr. 14, 2020.

(51) Int. Cl. G06K 9/00; G06K 9/40; G06K 9/62

(52) U.S. Cl. CPC G06K 9/00718; G06K 9/00228; G06K 9/00335; G06K 9/6218; G06K 9/40

(57) ABSTRACT

Methods and systems for video analysis and response include detecting face images within video streams. Noisy images are filtered from the detected face images. Batches of the remaining detected face images are clustered to generate mini-clusters, constrained by temporal locality. The mini-clusters are globally clustered to generate merged clusters formed of face images for respective people, using camera-chain information to constrain a set of the video streams being considered. Analytics are performed on the merged clusters to identify a tracked individual's movements through an environment. A response is performed to the tracked individual's movements.

### RELATED APPLICATION INFORMATION

This application claims priority to U.S. Patent Application No. 63/009,701, filed on Apr. 14, 2020, and to U.S. Patent Application No. 63/035,292, filed on Jun. 5, 2020, incorporated herein by reference in their entirety.

### BACKGROUND

### Technical Field

The present invention relates to face matching, and, more particularly, to clustering face images from video streams.

### Description of the Related Art

Video cameras are used in a variety of applications, such as for use in security monitoring. As the number of video surveillance systems increases, so too does the amount of recorded video information. Performing analytics on such large amounts of data is challenging, as the complexity of the analytics increases along with the amount of information that is being analyzed.

### SUMMARY

A method for video analysis and response includes detecting face images within a plurality of video streams. Noisy images are filtered from the detected face images. Batches of the remaining detected face images are clustered to generate mini-clusters, constrained by temporal locality. The mini-clusters are globally clustered to generate merged clusters formed of face images for respective people, using camera-chain information to constrain a set of the plurality of video streams being considered. Analytics are performed on the merged clusters to identify a tracked individual's movements through an environment. A response is performed to the tracked individual's movements.

A system for video analysis and response includes a video interface that receives a plurality of video streams, a hardware processor, and a memory that stores a computer program product. When executed, the computer program product causes the hardware processor to detect face images within the video streams, filter noisy images from the detected face images, cluster batches of the remaining detected face images to generate mini-clusters, constrained by temporal locality, globally cluster the mini-clusters to generate merged clusters formed of face images for respective people, using camera-chain information to constrain a set of the plurality of video streams being considered, perform analytics on the merged clusters to identify a tracked individual's movements through an environment, and respond to the tracked individual's movements.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram of an environment that includes a number of video cameras that track movements of individuals, in accordance with an embodiment of the present invention;

FIG. 2 is a block diagram of a video analysis and response system that receives video streams from multiple video cameras, in accordance with an embodiment of the present invention;

FIG. 3 is a block/flow diagram of a method for clustering face images across multiple video streams, in accordance with an embodiment of the present invention;

FIG. 4 is a block/flow diagram of a method for discovering camera-chain information across multiple video streams, in accordance with an embodiment of the present invention;

FIG. 5 is a block/flow diagram of a method for filtering faces in video streams, in accordance with an embodiment of the present invention;

FIG. 6 is a block/flow diagram of a method for clustering faces across multiple video streams, in accordance with an embodiment of the present invention;

FIG. 7 is a block/flow diagram of a method for building camera chains from association rules, in accordance with an embodiment of the present invention;

FIG. 8 is a block/flow diagram of a method of performing contact tracing using face clustering, in accordance with an embodiment of the present invention; and

FIG. 9 is a block diagram of a video analysis and response system, in accordance with an embodiment of the present invention.

### DETAILED DESCRIPTION OF PREFERRED EMBODIMENTS

One form of analysis that can be performed on video streams is clustering, and face clustering in particular. Face clustering helps to identify images of a person's face across video streams, and overtime within video streams. This information can be used to extract useful data, for example by making it possible to track a person's movement through a space. In addition, the movement of many such people can be considered in aggregate, providing statistics and demographic information.

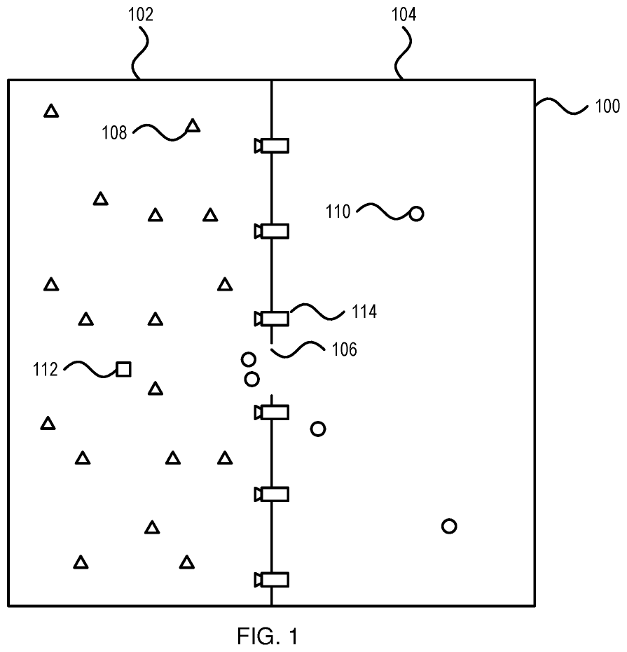

Referring now in detail to the figures in which like numerals represent the same or similar elements and initially to FIG. 1, an environment 100 is shown. For example, one type of environment that is contemplated is a mall or shopping center, which may include a common space 102 and one or more regions 104, such as a store. It should be understood that this example is provided solely for the purpose of illustration, and should not be regarded as limiting.

A boundary is shown between the common space 102 and the region 104. The boundary can be any appropriate physical or virtual boundary. Examples of physical boundaries include walls and rope—anything that establishes a physical barrier to passage from one region to the other. Examples of virtual boundaries include a painted line and a designation within a map of the environment 100. Virtual boundaries do not establish a physical barrier to movement, but can nonetheless be used to identify regions within the environment. For example, a region of interest may be established next to an exhibit or display, and can be used to indicate people's interest in that display. A gate 106 is shown as a passageway through the boundary, where individuals are permitted to pass between the common space 102 and the region 104.

The environment 100 is monitored by a number of video cameras 114. Although this embodiment shows the cameras 114 being positioned at the gate 106, it should be understood that such cameras can be positioned anywhere within the common space 102 and the region 104. The video cameras 114 capture live streaming video of the individuals in the environment. A number of individuals are shown, including untracked individuals 108, shown as triangles, and tracked individuals 110, shown as circles. Also shown is a tracked person of interest 112, shown as a square. In some examples, all of the individuals may be tracked individuals. In some examples, the tracked person of interest 112 may be tracked to provide an interactive experience, with their motion through the environment 100 being used to trigger responses.

In addition to capturing visual information, the cameras 114 may capture other types of data. For example, the cameras 114 may be equipped with infrared sensors that can read the body temperature of an individual. In association with the visual information, this can provide the ability to remotely identify individuals who are sick, and to track their motion through the environment.

As a tracked individual 110 moves through the environment 100, they may move out of the visual field of one video camera 114 and into the visual field of another video camera. The tracked individual 110 may furthermore enter a region that is not covered by the visual field of any of the video cameras 114. Additionally, as the tracked individual 110 moves, a camera's view of their face may become obstructed by clothing, objects, or other people. The different images of the tracked individual's face, across time and space, may be clustered together to associate videos of the tracked individual in different places and at different times with one another. Thus, each cluster may be formed from faces of a single person.

The clustered face information may be used to gather information about the movement of individuals, both singly and in aggregate. For example, consider a business that wants to obtain demographic information about its customers. Face clustering across video streams can help the business determine the number of distinct customers, the number of returning customers, time spent at the business, time spent at particular displays within the business, and demographic information regarding the customers themselves. Clustering can benefit the identification of demographic information for a customer, for example by providing averaging across a variety of different poses, degrees of occlusion, and degrees of illumination.

Face clustering can also help track the motion of individuals across the environment. This type of tracking is of particular interest in performing contact tracing. For example, in the event of a pandemic, the identification of contacts between infected individuals and other individuals can help to notify those other individuals of their risk, before they become contagious themselves. In such an application, the environment 100 may not be limited to a single building or business, but may cover a large municipal or geographical area, including a very large number of cameras 114.

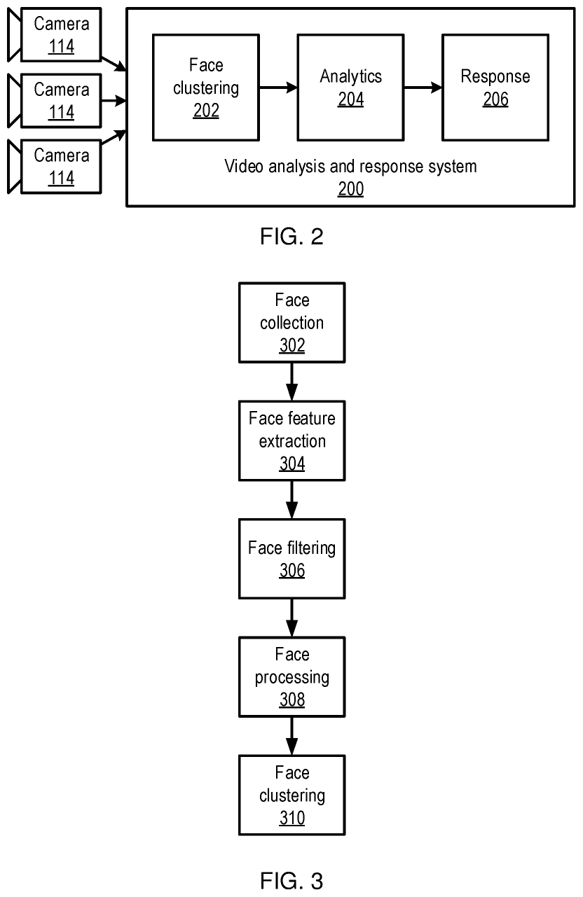

Referring now to FIG. 2, a block diagram of a video analysis and response system 200 is shown. Cameras 114 provide their respective video streams to the system 200. The system 200 performs face clustering 202. For each person in the video streams, face clustering 202 identifies images of their face and assigns all such images to a same cluster. Using the clustered face information, analytics 204 performs some analysis on the video streams to determine one or more facts about the recorded video. Response 206 then uses the determined fact(s) to perform some action, such as a security action, a promotional action, a health & safety action, or a crowd control action. It should be noted that, although the present description focuses on face images, the same principles may be applied to clustering images of any object, such as vehicles, animals, etc.

When performing face clustering 202, there may be several constraints. For example, the true number of distinct people may not be known. The number of clusters may be large and continuously changing. The faces of two distinct people may be clustered together, if a similarity estimate between them is determined to be sufficiently high.

Face images that are detected in the video streams may be stored in a database within the system along with extracted features. Each face record may include a unique face identifier, a detection timestamp, a camera/stream identifier, and a face image quality score. Camera-to-location and location-to-camera information may be collected as well, which can help select subsets of faces that are associated with particular locations of interest.

In some cases, the cameras 114 may have disjoint fields of view, such that a tracked individual 110 may not be in the view of two cameras at once. Additionally, whenever a face has been detected, it can be assumed that more face detections will occur within a short timespan, for example as the person moves within the camera's field of view. Face clustering 202 may use this information to quickly process a large set of faces, collected across a variety of cameras 114.

The clustering process may continuously cluster face images in mini-batches, based on camera identifiers. Clustering may be computationally intensive, with clustering m faces having a complexity of O(m²), such that the number of pair-wise similarity computations increases as the square of the number of faces. A large environment 100, with many cameras 114, may generate a very large number of face images, making it challenging to cluster all of them.

Worker processes may run in parallel to generate mini-batch clustering information based on temporal locality, thereby decreasing the number of faces being processed in each mini-batch. From each mini-batch cluster, a mini-batch cluster representative may be selected based on a quality score. The representatives include information about other faces in their cluster, so that related information can be easily accessed. Global clustering information can then be generated, for example using camera chains. This global clustering information may then be saved, along with metadata related to the detected faces. An index of the cluster information can be used to quickly generate analytics of interest. Clustering can further be accelerated and improved by using past similarity comparisons and by filtering out noisy images.

Referring now to FIG. 3, a method for clustering faces is shown. Block 302 gathers face images from the video cameras 114. These face images may come from live camera feeds from predetermined locations of interest within the environment 100. Individual frames may be extracted from the feeds. Face feature extraction 304 takes the extracted video frames and performs face detection. For each detected face, face feature extraction 304 generates a feature vector representation using a face recognition image. The meaning of the contents of the feature vector representations may not be known.

Face filtering 306 takes a face, represented by a feature vector, and determines whether the face image is noisy. Additional detail on face filtering 306 is provided below. Face processing 308 may determine metadata for the face images, such as demographic information, facial expression, etc., and may then store high-quality faces with relevant metadata into a database. Stored faces may further be indexed based on their cluster identifiers.

Face clustering 310 may continuously read face images from the face storage. Similar faces may be assigned to the same cluster identifier. Face clustering 310 may make use of camera mapping information to speed clustering, as described in greater detail below.

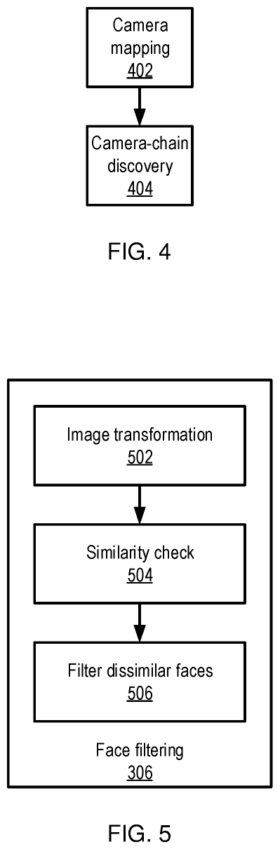

Referring now to FIG. 4, a method of generating camera mapping information is shown. Block 404 maps cameras 114 to locations within the environment 100. Whenever a camera 114 is installed, it may be assigned a unique camera identifier, with information about the camera and its location being stored in a mapping table. Cameras 114 may furthermore be added to groups to cover a particular location, which may be stored in a camera grouping table.

Block 404 uses stored face clustering information to discover locations that are most frequently visited by people and records the association between face clusters and the respectively visited locations. This information may be stored in a camera-chain table.

Referring now to FIG. 5, additional detail on face filtering 306 is shown. Cameras 114 may have a large field of view, capturing many faces that are not frontal poses of the person. Face recognition models may identify different face images of the same person to be dissimilar when there is a large variation in blur, occlusion, angles, poses, lighting conditions, etc., between the images being compared. These erroneous results may result in the creation of multiple clusters for a single person and the creation of a single cluster for face images of two different people.

To help detect noisy images, block 502 performs an image transformation. For example, the transformed image may flip the image along a vertical axis. Any appropriate transformation may be used for this purpose. Block 504 then performs a similarity check between the original image and the transformed image. This similarity check may include performing feature extraction on the transformed image, so that the features of the original and the transformed image can be compared. Any appropriate similarity metric may be used, and the operation of the similarity metric may not be knowable.

Block 506 then filters out noisy images. The determination of whether the image is noisy may be made based on the similarity check of block 504. For example, if a similarity score generated by block 506 is below a predetermined threshold, then the original image may be considered to be noisy and may be filtered out.

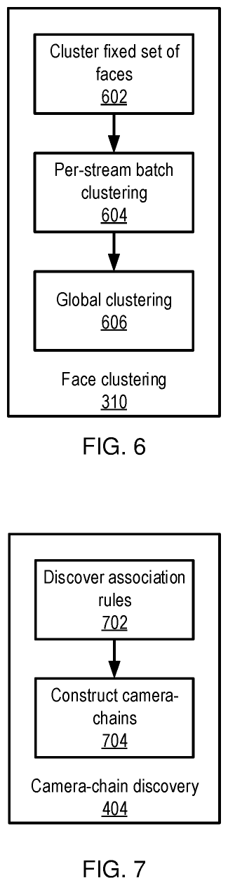

Referring now to FIG. 6, additional detail is provided for face clustering 310. Block 602 performs fast clustering on a fixed set of faces. Metadata may be tracked for each face image, for example including a face identifier, a cluster identifier, and a set of the top K previous matches. The previous matches are used to select a subset of the existing clusters during cluster assignment for a face image. This may be represented as a priority queue which has at most K entries, sorted in descending order of the match score, corresponding to K different clusters.

Block 602 may sort face images in order of their capture time. To assign a cluster to a face image, it may be compared against faces in the clusters listed in the top K previous matches. If a match is found in one of the top K clusters, the corresponding cluster identifier is added to the face image under consideration. If a match is found in multiple clusters of the top K clusters, then all matching clusters may be merged into one, and the cluster identifier of the merged cluster may be assigned to the face image under consideration. If no match is found in the top K clusters, a new cluster may be formed, with a new cluster identifier, and the new cluster identifier may be assigned to the face image under consideration.

The face under consideration may then be compared with other unassigned faces, which have yet to be clustered. If any of the unassigned faces matches with the face under consideration, they may be assigned the same cluster identifier as the face under consideration. For each non-matched, unassigned face, the matching score with respect to the face under consideration may be added to the top K previous matches for the non-matched, unassigned face. The above process may be repeated for each unmatched face image, until they are all matched to a cluster.

Block 604 then performs batch clustering on a per-stream basis. The batch may be defined as a set of contiguous face images, captured in a predetermined duration of a video stream. For example, the batch duration may be about 30 seconds. Faces in video streams may show a high degree of temporal locality. Thus, mini-clusters may be formed for each video stream for a mini-batch of face images, using the clustering of block 602. Once clustering has been performed, for each mini-cluster, block 602 may assign representatives to the clusters. For example, each representative may be assigned as the face image having the highest self-similarity score with its transformed image, as in blocks 502 and 504 above.

Block 606 performs global clustering. The representatives of the mini-clusters, produced in block 604, are processed to form global clusters. The process of block 606 may be similar to that of block 602, using the representative face images to merge mini-clusters together.

Block 606 first divides face images into groups using camera grouping and camera chain information. Faces in each group are processed using the clustering described above with respect to block 602. The representatives of the clusters in each group are clustered to form a final clustering output. This clustering may be performed using the disjoint property of the video streams, where it can be assumed that a person may not be present in to disjoint locations at the same time. This makes it possible to skip a significant number of similarity comparisons, such as any face images that are taken with a similar time stamp, but from a different video stream.

Camera-chain and camera grouping information can be used to limit the number of cameras that are considered during global clustering. For example, a person cannot instantly move from the view of one camera 114 to the view of another camera 114 that is very far away. Instead, the person may have to cross the fields of view of multiple different cameras to reach the distant camera. The camera-chain information encodes which cameras 114 are likely to capture video of the person next, so that global clustering 606 may omit face images from those cameras 114 which are unlikely.

Referring now to FIG. 7, additional detail on the camera-chain discovery of block 404 is shown. This process may run periodically, to generate information about camera locations which are accessed frequently by the same visitors. This information may be used to discover camera-chains. The clustering of blocks 602 and 606 is accelerated by there being many face images related to a single person in the input set of face images.

Block 702 gathers cluster information and finds, for each cluster, a list of camera identifiers associated with all of the face images in the cluster. Block 702 then identifies association rules that connect clusters to frequently visited camera identifiers. For example, block 702 may use Apriori association rule learning.

Block 704 forms camera-chains. A graph may be formed, with each node corresponding to a camera identifier. The total number of nodes in the graph may therefore equal the total number of cameras 114 at various locations of interest. For each association rule that satisfies a predefined Apriori support threshold, and a predefined Apriori minimum value for confidence, an edge may be formed between corresponding nodes. All of the connected components in the graph are identified, with each connected component representing a camera-chain. The edges represent passage of a person from the visual field of one camera to the next, to encode geographic locality.

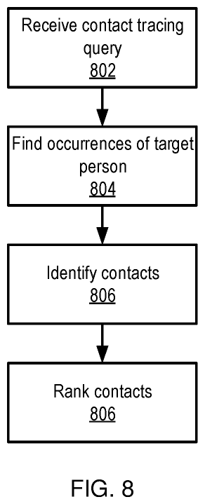

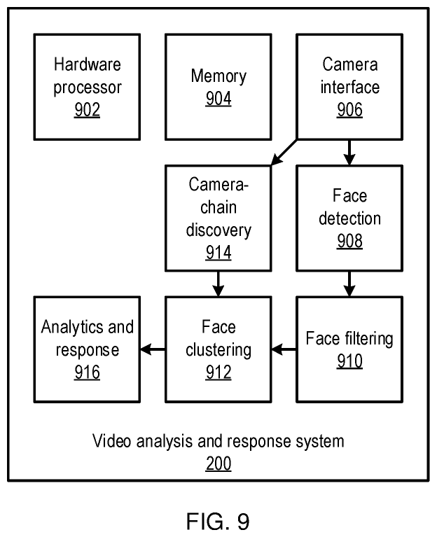

Referring now to FIG. 8, a method for performing contact tracing is shown. Block 802 receives a contact tracing query. The query may include, for example, a target person's face image, a contact duration threshold, and a time range. In some cases, the query may be generated automatically, for example upon detection of a person with a temperature that indicates a fever. In other cases, the query may be generated by a request that occurs substantially after the video streams are recorded, for example when it is determined that the individual is contagious. The query may request, for example, a ranked list of contacts who were with the target person for at least the specified contact duration threshold, within the defined time range. Other parameters that may be included with the query may include a list of camera locations to restrict the search, a similarity threshold for matching faces, and a session window for determining the duration of the time that the people were in contact.

Block 804 identifies occurrences of the target person. Identifying the occurrences of the target person may include extracting features from the queried face image. This may be performed using the same face recognition as is used in block 304 above. Clusters may then be identified by matching the face image of the query to representative face images of the different clusters. For example, the highest-quality face images from each cluster may be considered, with the query face image being compared to each to determine similarity. If the similarity score satisfies a threshold, whether predefined or specified in the query, then the cluster may be considered to be a matching cluster. When a matching cluster is found, the face images associated with the cluster indicate the detected location of the individual by association to their respective camera identifiers.

Block 806 identifies people who have come into contact with the target person. This may include, for example, reviewing stored face images that were taken at the same time (e.g., within a specified time range) as an occurrence of the target person, and that share a camera identifier. Block 806 may aggregate face images that belong to the same person into a single contact.

Block 808 may rank the identified contacts, for example based on time spent with the target person and/or the physical proximity of the contact. To estimate the amount of time spent in proximity, a session duration may be defined. For example, if the session duration is five seconds, and the contact was seen within five seconds of the target person, then it may be determined that the contact and the target person have spent five seconds of time together. If they are seen together again within the session duration, then it is determined that they spent ten seconds together. This may be continued, with the session duration increasing in increments, until a session duration passes with the two not being seen together. During a given contact duration, it may be determined that the contact and the target person may have had multiple sessions of contact.

Ranking may give more weight to the time of a single session than to the total number of sessions, with time lasting longer than a threshold duration representing high risk. This threshold may be defined by the query or may be a predetermined number. If a contact cᵢ spends t₁, . . . , tₙ amount of time near the target person in n different sessions, then a rank score may be determined according to the following function:

$$score ( {c}_{i} ) = {\sum }_{s = 1}^{n} \frac{1}{1 + exp ( - {t}_{s} - \frac{{t}_{q}}{2} )}$$

where t_{q} is the duration threshold parameter.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Referring now to FIG. 2, additional detail on the video analysis and response system 200 is shown. The system 200 includes a hardware processor 902 and a memory. A camera interface 906 receives video streams from the cameras 114 by any appropriate wired or wireless communications protocol. For example, the camera interface 906 may receive digital or analog video signals through a dedicated interface, or may receive them via a computer network.

The video streams are used for face detection 908. Low-quality face images are removed by face filtering 910, and face clustering 912 collects the images of individuals' faces into respective clusters. Camera-chain discovery 914 uses the video streams to identify cameras 114 that are frequently visited by particular individuals. Face clustering 912 uses the camera-chain information to help accelerate the clustering process.

Based on the face clustering information, analytics and response 916 performs analysis on the video streams. For example, the analysis may determine information about the interests and habits of the tracked individuals, using the face clusters. As noted above, this analysis may include identifying customer interests, but may also be used to identify contacts between an infected individual and other people.

Actions that may be performed include automatically changing displays in accordance with customers' interest, performing contact tracing, and notifying individuals who were in contact with an infected person.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for video analysis and response, comprising:
detecting face images within a plurality of video streams;
filtering noisy images from the detected face images;
clustering batches of the remaining detected face images to generate mini-clusters, constrained by temporal locality;
globally clustering the mini-clusters to generate merged clusters formed of face images for respective people, using camera-chain information to constrain a set of the plurality of video streams being considered;
performing analytics on the merged clusters to identify a tracked individual's movements through an environment; and
responding to the tracked individual's movements.

2. The method of claim 1, further comprising determining a camera-chain from the video streams assuming that the video streams are disjoint.

3. The method of claim 2, wherein the camera-chain includes a graph of connections between video stream nodes, with the connections representing geographic locality between nodes.

4. The method of claim 2, wherein globally clustering the mini-clusters includes excluding video streams that a person is unlikely to transition to from a particular video stream.

5. The method of claim 1, wherein filtering noisy images from the detected face images comprises:
transforming the detected face images to generate respective transformed images;
comparing each detected face image to the respective transformed image to identify noisy images; and
removing the noisy images.

6. The method of claim 5, wherein comparing each detected face image to the respective transformed image includes determining that a similarity score of the detected face image to the respective transformed image is lower than a predetermined threshold.

7. The method of claim 5, wherein transforming the detected image includes flipping the detected image.

8. The method of claim 1, wherein responding to the tracked individual's movements includes an action selected from the group consisting of a security action, a promotional action, a health & safety action, and a crowd control action.

9. The method of claim 1, wherein the analytics include contact tracing to determine an exposed individual who was in contact with the tracked individual, and wherein responding to the tracked individual's movements includes notifying the exposed individual of their exposure.

10. The method of claim 9, wherein contact tracing includes determining a degree of exposure, including a time spent in proximity to the tracked individual.

11. A system for video analysis and response, comprising:
a video interface that receives a plurality of video streams;
a hardware processor; and
a memory that stores a computer program product, which, when executed by the hardware processor, causes the hardware processor to:
detect face images within a plurality of video streams;
filter noisy images from the detected face images;
cluster batches of the remaining detected face images to generate mini-clusters, constrained by temporal locality;
globally cluster the mini-clusters to generate merged clusters formed of face images for respective people, using camera-chain information to constrain a set of the plurality of video streams being considered;
perform analytics on the merged clusters to identify a tracked individual's movements through an environment; and
respond to the tracked individual's movements.

12. The system of claim 11, wherein the computer program product further causes the hardware processor to determine a camera-chain from the video streams assuming that the video streams are disjoint.

13. The system of claim 12, wherein the camera-chain includes a graph of connections between video stream nodes, with the connections representing geographic locality between nodes.

14. The system of claim 12, wherein the computer program product further causes the hardware processor to exclude video streams, which a person is unlikely to transition to from a particular video stream, from the global clustering.

15. The system of claim 11, wherein the filtration of noisy images includes:
a transformation of the detected face images to generate respective transformed images;
a comparison of each detected face image to the respective transformed image to identify noisy images; and
removal of the noisy images.

16. The system of claim 15, filtration of noisy images includes a determination that a similarity score of the detected face image to the respective transformed image is lower than a predetermined threshold.

17. The system of claim 15, wherein the transformation includes flipping the detected image.

18. The system of claim 11, wherein the computer program product further causes the hardware processor to respond to the tracked individual's movements with an action selected from the group consisting of a security action, a promotional action, a health & safety action, and a crowd control action.

19. The system of claim 11, wherein the analytics include contact tracing to determine an exposed individual who was in contact with the tracked individual, and wherein the computer program product further causes the hardware processor to respond to the tracked individual's movements a notification to the exposed individual of their exposure.

20. The system of claim 19, wherein contact tracing includes a determination of a degree of exposure, including a time spent in proximity to the tracked individual.
